(19) United States
(12) Patent Application Publication
(10) Pub. No.: US 2011/0161657 A1
(43) Pub. Date: Jun. 30, 2011

(54) METHOD AND SYSTEM FOR PROVIDING TRAFFIC HASHING AND NETWORK LEVEL SECURITY

(75) Inventor: Ning So, Plano, TX (US)

(73) Assignee: VERIZON PATENT AND LICENSING INC., Basking Ridge, NJ (US)

(21) Appl. No.: 12/651,047

(22) Filed: Dec. 31, 2009

(51) Int. Cl. H04L 29/06

(52) U.S. Cl. 713/153

(57) ABSTRACT

An approach is provided for enabling traffic hashing and network level security. A unit of transmission associated with a flow of network traffic is received at a routing node. The unit of transmission is encrypted. A pseudo-address to assign to the encrypted unit of transmission is determined. The pseudo-address is assigned to the encrypted unit of transmission.

### BACKGROUND INFORMATION

Telecommunication networks have developed from connection-oriented, circuit-switched (CO-CS) systems, such as the public switched telephone network (PSTN), utilizing constant bit-rate, predefined point-to-point connections to connectionless, packet-switched (CNLS) systems, such as the Internet, utilizing dynamically configured routes characterized by one or more communication channels divided into arbitrary numbers of variable bit-rate channels. With the increase in demand for broadband communications and services, telecommunication service providers are beginning to integrate long-distance, large-capacity optical communication networks with these traditional CO-CS and CNLS systems. Typically, these communication networks utilize multiplexing transport techniques, such as time-division multiplexing (TDM), wavelength-division multiplexing (WDM), and the like, for transmitting information over optical fibers. However, an increase in demand for more flexible, resilient transport is driving communication networks toward high-speed, large-capacity packet-switching transmission techniques that enable switching and transport functions to occur in optical states via one or more packets. This technological innovation carries with it a new burden to provision reliable service over these networks, i.e., service that is capable of withstanding link and node failure while also maintaining high transmission capacity. As a result, traffic engineering plays an important role in providing high network reliability and performance. One key aspect of traffic engineering is load balancing, such as multipath load balancing that enables flows of network traffic to be transported via different paths. Traffic hashing may be utilized to partition the flows of network traffic and, thereby, may be employed to optimize network utilization and reduce packet disordering. Traffic hashing techniques, however, can be thwarted by network level security functions, such as firewall and encryption functions.

Therefore, there is a need for an approach that can efficiently and effectively provide both traffic hashing and network level security functions.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system configured to support traffic hashing and network level security, according to an exemplary embodiment;

FIG. 2 is a diagram of an aggregation node configured to assign addressing information to encrypted network traffic, according to an exemplary embodiment;

FIG. 3 is a flowchart of a process for assigning addressing information to encrypted network traffic, according to an exemplary embodiment;

FIG. 4 is a diagram of an edge node configured to hash encrypted network traffic, according to an exemplary embodiment;

FIG. 5 is a flowchart of a process for hashing encrypted network traffic, according to an exemplary embodiment; and

FIG. 6 is a diagram of a computer system that can be used to implement various exemplary embodiments.

### DESCRIPTION OF THE PREFERRED EMBODIMENT

A preferred apparatus, method, and software for providing traffic hashing and network level security are described. In the following description, for the purposes of explanation, numerous specific details are set forth in order to provide a thorough understanding of the preferred embodiments of the invention. It is apparent, however, that the preferred embodiments may be practiced without these specific details or with an equivalent arrangement. In other instances, well-known structures and devices are shown in block diagram form in order to avoid unnecessarily obscuring the preferred embodiments of the invention.

Although various exemplary embodiments are described with respect to traffic hashing over particular networks utilizing certain protocols, it is contemplated that various exemplary embodiments are applicable to other equivalent protocols and transport networks.

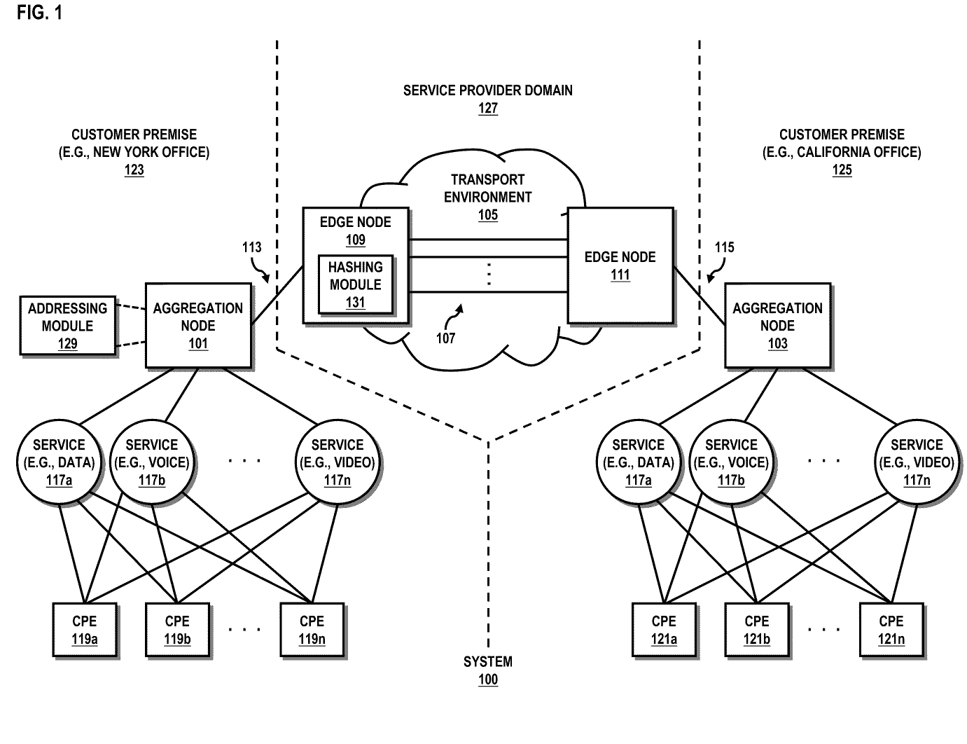

FIG. 1 is a diagram of a system configured to support traffic hashing and network level security, according to an exemplary embodiment. For illustrative purposes, system 100 is described with respect to aggregation nodes 101 and 103 configured to provide random address assignments for post encrypted network traffic in order to facilitate network traffic hashing over transport environment 105. By way of example, transport environment 105 may be (or include) one or more packet-switched (e.g., Internet Protocol (IP) based) networks configured for the transport of information (e.g., data, voice, video, etc.) between one or more source aggregation nodes (e.g., aggregation node 101) and one or more destinations aggregation nodes (e.g., aggregation node 103) via one or more links (or pathways) 107 extending between, for example, edge routers 109 and 111 of (or associated with) transport environment 105. In this manner, aggregation nodes 101 and 103 may be provided access to transport environment 105 via links (or pathways) 113 and 115, respectively. While specific reference will be made hereto, it is contemplated that system 100 may embody many forms and include multiple and/or alternative components and facilities.

Traffic engineering (TE), i.e., the ability to control and manipulate the flow of network traffic, may be utilized to alleviate the burden associated with provisioning reliable service over emerging networks via resource reservation, fault-tolerance, and optimization of transmission resources, such as optimization via load balancing techniques that enhance network performance and reliability. In this manner, the transmission of information over a transport environment typically involves sending messages between one or more application programs executing on (or by) host processors (or processing systems) communicatively coupled to the transport environment via, for instance, one or more aggregation routers. The host processors may be configured to encapsulate the information into one or more units of transmission, such as one or more blocks, cells, frames, packets, etc., which may be associated with one or more flows of network traffic corresponding to one or more applications (or services) provided or facilitated by the host processors. The aggregation routers may be provided access to the transport environment by way of one or more edge nodes configured to provision the unit(s) of transmission (and/or the flows of network traffic) to one or more physical and/or logical links (or pathways) of the transport environment based on, for instance, one or more hash values and/or traffic engineering parameter(s) related to the pathways. It is noted that these pathways provide redundant connectivity and the potential to distribute traffic loading effectively and, thereby, reduce traffic congestion. As such, when a receiving host processor receives one or more units of transmission from an edge node of (or associated with) the transport environment, the receiving host processor may be configured to decapsulate the unit of transmission to obtain the information transmitted by way of the unit of transmission. The obtained information may, in turn, be provided to customer premise equipment addressed by the unit of transmission.

With the exponential growth in IP based traffic, parallel architectures offer a scalable approach to processing units of transmission via routing nodes. Namely, instead of utilizing a central processing engine, units of transmission may be dispatched to multiple processing engines of (or associated with) a routing node to increase the overall processing throughput of the router and, thereby, the architecture utilizing hashing techniques. These same techniques may be applied with respect to IP based servers, gateways, and like, providing one or more data, voice, and/or video services. That is, a routing node may utilized to split network traffic to different ports that are connected to different servers, gateways, etc., in support of the data, voice, and/or video services based on hashing techniques. Still further, routing nodes may split flows of network traffic associated with the data, voice, and/or video services into one or more sub-flows based on hashed source and destination information of the sub-flow of network traffic.

For instance, a client may have two offices geographically dispersed from one another, but provisioned to exchange information associated with a plurality of services (e.g., data, voice, and video services) via one or more transport environments. As such, the offices may include aggregation nodes (or routers) that handle connections between the offices and edge nodes of (or associated with) the transport environment. These aggregation nodes may respectively provide connectivity to a data server, voice gateway, and video server. The data servers may have associated IP addresses and may, in turn, provide data services to respective numbers of computing devices, such as “N” and “M” computing devices, each being uniquely associated with corresponding machine access control (MAC) addresses. The voice gateway and the video server may be connected to the aggregation routers via local area networks and, thereby, may be addressed based on associated virtual local area network (VLAN) addresses. As such, the edge nodes of (or associated with) the transport environment may be configured to receive aggregated network traffic flows from the aggregation routers; however, may be enabled to split the aggregated network traffic flows into pluralities of sub-flows, e.g., one sub-flow for video service network traffic, one sub-flow for voice service network traffic, and “N” times “M” sub-flows for data services between the source/destination addresses of the computing devices, utilizing traffic hashing techniques applied based on source/destination addressing information.

It is recognized, however, that information transmitted over, for instance, publically shared transport environments, such as the backbone infrastructure of a service provider, may be subject to network level security measures, such as firewall and encryption services, to prevent the interception and disclosure of the information to unauthorized parties. Typically, aggregation nodes will encrypt and/or obfuscate the addressing information of a unit of transmission using a cipher algorithm and one or more encryption keys (or codes). As such, application of traffic hashing techniques based on source/destination addressing information by the edge nodes would be thwarted as the addressing information associated with encrypted and/or obfuscated units of transmission would be unknown to the edge nodes.

Therefore, the approach of system 100, according to certain exemplary embodiments, stems from the recognition that providing post encryption pseudo-address assignment for encrypted units of transmission enables edge routers receiving the encrypted network traffic to implement traffic hashing techniques based, at least, on the pseudo-address assignments. In certain embodiments, the pseudo-addresses may be randomly generated based on the source and destination information specified by a unit of transmission before the unit of transmission is encrypted. As such, the randomly generated pseudo-addresses may be uniquely assigned to particular flows and/or sub-flows of network traffic associated with particular services, such as data, voice, and/or video services. In certain implementations, the pseudo-address assignments may be temporary and, thereby, periodically modified or otherwise changed, which may be utilized to increase security measures. It is further noted that edge routers providing connectivity between source and destination aggregation nodes will be privy to source and destination addressing information associated with the source and destination aggregation nodes. As such, other exemplary embodiments stem from the recognition that the traffic hashing techniques of the edge nodes may be improved by additionally utilizing the source and destination addressing information associated with the source and destination aggregation nodes in implementing the traffic hashing techniques.

As seen in FIG. 1, aggregation nodes 101 and 103 are configured to aggregate network traffic associated with one or more services, such as services 117a-117n. According to exemplary embodiments, services 117a-117n may relate to any suitable service, such as any suitable data, voice, and/or video service. In this manner, services 117a-117n may be provided to one or more clients at (or associated with), for instance, a variety of customer premise equipment (CPE), such as CPEs 119a-119n and 121a-121n. As such, services 117a-117n may be configured as host processors (or processing systems) configured to encapsulate information associated with services 117a-117n into one or more units of transmission, such as one or more blocks, cells, frames, packets, etc., which may be associated with one or more flows of network traffic corresponding to one or more applications (or services) provided or facilitated by services 117a-117n. In general, these units of transmission may include “header” portions (or fields) and “payload” portions (or fields). Header fields typically provide supplemental information concerning information to be transported, while payload fields carry the “random” information submitted for transportation, such as the random information associated with one or more of services 117a-117n. As such, services 117a-117n may encapsulate information into a unit of transmission including one or more header fields specifying addressing information, e.g., source and destination addresses of corresponding CPEs configured to originate and terminate a flow of network traffic including the unit of transmission.

According to exemplary embodiments, units of transmission associated with services 117a-117n may be aggregated at aggregation nodes 101 and 103 that are configured to respectively provide customer premises 123 and 125 with connectivity to transport environment 105. In this manner, aggregation routers 101 and 103 may serve as gateways for inter-area network traffic and, thereby, may summarize (or aggregate) a number of sub-nets or network address components into single aggregated addresses that can be utilized to transport units of transmission over transport environment 105. While not necessary, such address aggregation enables scaling of routing protocols, such as open-shortest path first (OSPF) and intermediate system to intermediate system (IS-IS), to large domains, such as service provider domain 127, as address aggregation enables significant reductions in routing tables and link state databases, as well as less network traffic to synchronize link state databases.

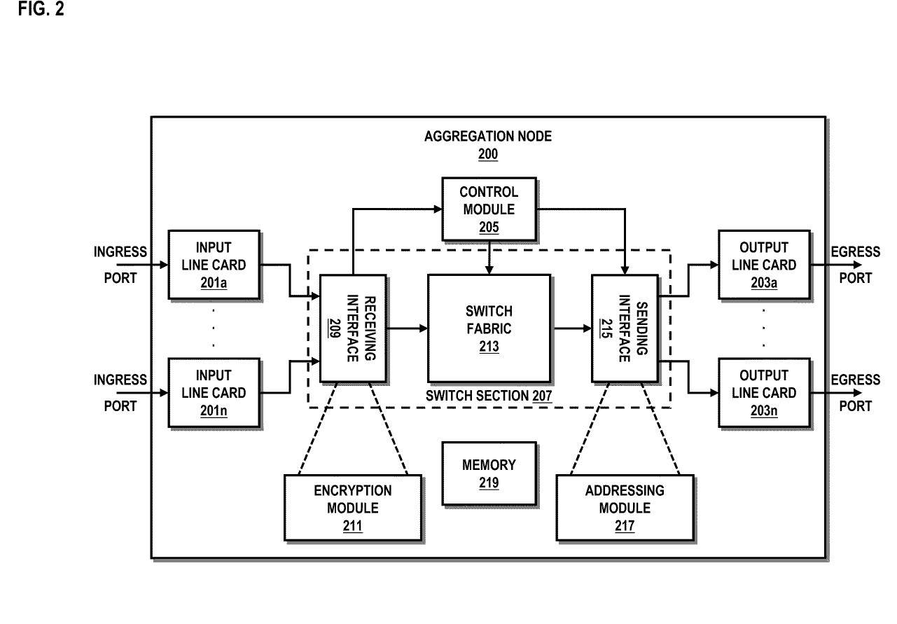

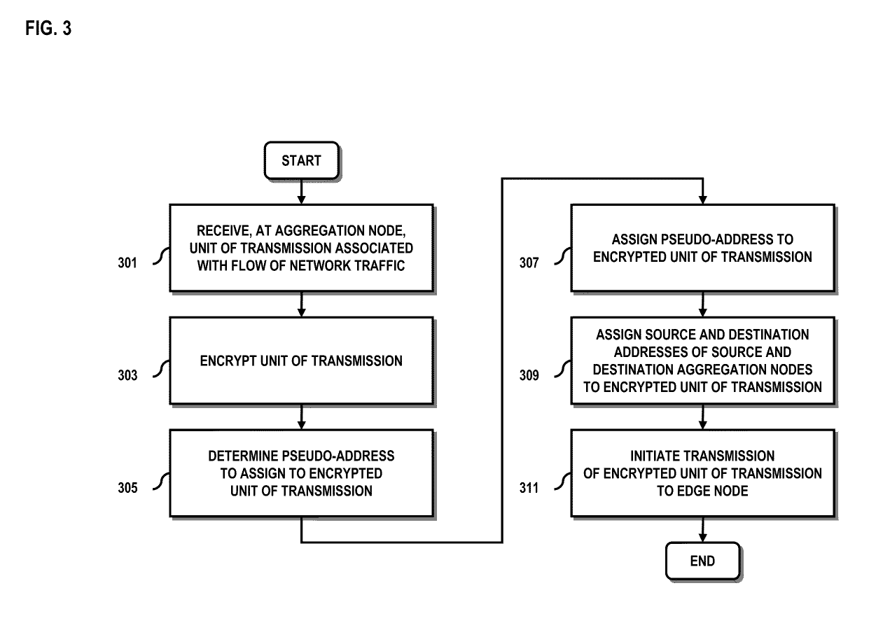

Aggregation nodes 101 and 103 may, in exemplary embodiments, be configured to support one or more network level security functions, such as firewall and/or encryption functions. In this manner, units of transmission received at aggregation nodes 101 and 103 for transport over transport environment 105 may be encrypted and/or obfuscated by aggregation nodes 101 and 103. Since encrypting and/or obfuscating the units of transmission implies loss of information provided to edge nodes 109 and 111, aggregation nodes 101 and 103 may include addressing modules (e.g., addressing module 129) to assign pseudo-addresses to post encrypted units of transmission. These pseudo-addresses may be randomly generated based on source and destination address information specified in one or more header fields and/or field segments of units of transmission received at aggregation nodes 101 and 103 from services 117a-117n. It is also contemplated that each unit of transmission associated with a particular flow or sub-flow of network traffic may be assigned a same pseudo-address. This may be utilized to uniquely identify the flow or sub-flow of network traffic. In this manner, the pseudo-addresses may be temporary and, thereby, periodically generated and associated with flows or sub-flows of network traffic. In certain embodiments, addressing modules 129 may also be configured to assign encrypted units of transmission addressing information associated with source and destination addressing information relating to a source aggregation node, e.g., aggregation node 101, and a destination aggregation node, e.g., aggregation node 103. Post encryption address assignment is described in more detail with FIGS. 2 and 3.

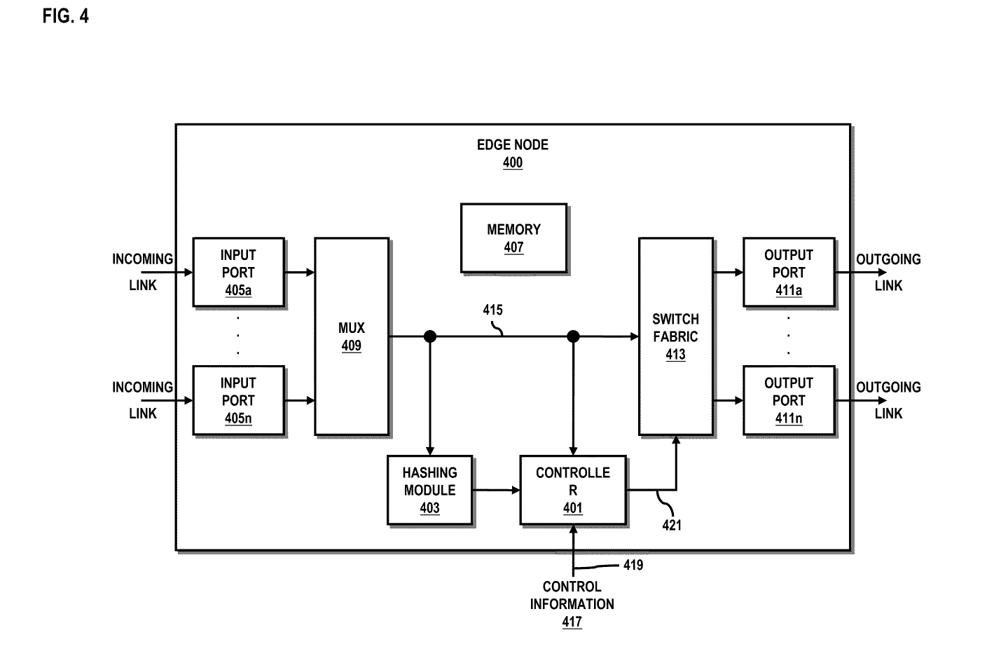

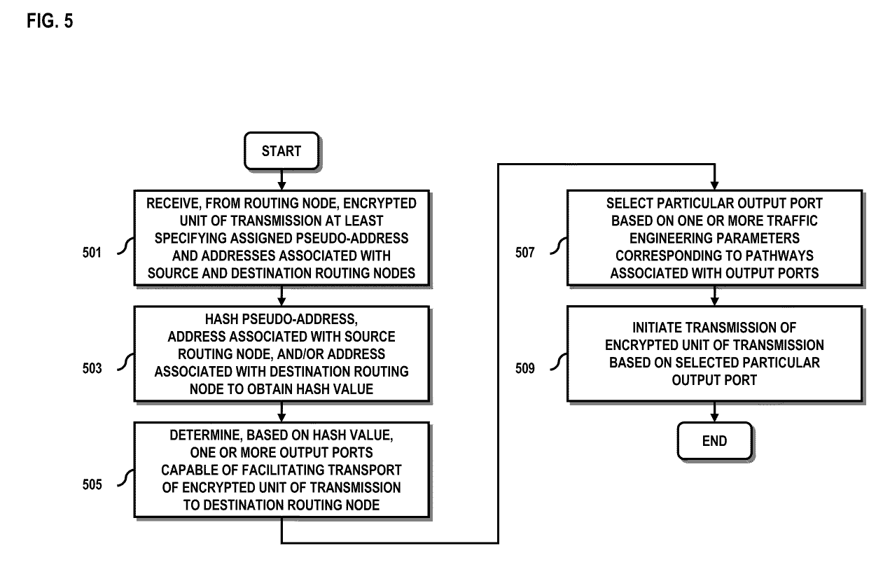

According to exemplary embodiments, aggregation nodes 101 and 103 access transport environment 105 via one or more edge nodes (e.g., edge nodes 109 and 111, respectively) by way of pathways 113 and 115. In this manner, units of transmission (e.g., blocks, cells, frames, packets, etc.) transported over transport environment 105 and, thereby, between edge nodes 109 and 111, may traverse one or more pathways 107 and/or nodes (not shown) of transport environment 105. These units of transmission may be provisioned to pathways 107 based on traffic hashing techniques applied by edge routers 109 and 111 via, for example, respective hashing modules of edge routers 109 and 111, such as hashing module 131 of edge node 109. As such, edge nodes 109 and 111 may be configured to filter ingress network traffic using one or more hashing functions applied to addressing information specified by the headers of encrypted units of transmission received from, for instance, aggregation routers 101 and 103. This addressing information may relate to pseudo-addressing information, source aggregation node addressing information, and/or destination aggregation node addressing information assigned by aggregation routers 101 and 103 post encryption. As such, hashing modules 131 may be configured to obtain one or more hash values that may be utilized to determine those pathways over transport environment 105 capable of supporting a flow, sub-flow, and/or unit of transmission. These pathways may be determined based on routing table information stored (or otherwise accessible) to edge nodes 109 and 111. Alternatively (or additionally), hash values may be uniquely assigned to egress ports (not shown) of edge nodes 109 and 111 and, as a result, the pathways may be determined based on the association of an obtained hash value with a corresponding egress port. In any event, however, encrypted units of transmission may be transported over particular ones of the determined pathways based on one or more traffic engineering parameters associated with pathways 107, such as administrative cost, available bandwidth, connection holding priorities, connection over-subscription factors, connection placement priorities, latency, loading conditions, and like. It is noted that traffic hashing and provisioning of network traffic to pathways 107 of transport environment 105 is described in more detail with FIGS. 4 and 5.

According to exemplary embodiments, aggregation nodes 101 and 103 may represent any suitable device configured to aggregate network traffic associated with one or more applications or services, such as services 117a-117n. That is, aggregation nodes 101 and 103 may be routers, servers, switches, terminals, workstations, etc., of a client (or subscriber) and may be associated with a particular customer premise. For instance, aggregation node 101 may be associated with a first customer premise, e.g., customer premise 123, such as a first office of the client located in, for example, New York, whereas aggregation node 103 may be associated with a second customer premise, e.g., customer premise 125, such as a second office of the client located in, for example, California. Similarly, edge nodes 109 and 111 may represent suitable routers, servers, switches, terminals, workstations, etc., of a service provider of, for example, transport environment 105. In exemplary embodiments, transport environment 105 may correspond to any suitable wired and/or wireless network providing, for instance, a local area network (LAN), metropolitan area network (MAN), wide area network (WAN), or a combination thereof. As such, transport environment 105 may additionally (or alternatively) correspond to a backbone network (or domain) 127 of a service provider or carrier. As such, transport environment 105 may operate as an asynchronous transfer mode (ATM) network, frame relay network, integrated services digital network (ISDN), internet protocol (IP) network, multiprotocol label switching (MPLS) network, synchronous optical networking (SONET) network, etc., and/or a combination thereof. Further, transport environment may employ various routing protocols, such as OSPF and IS-IS. These routing protocols may be utilized to determine pathways (or routes) 107 through transport environment 105, as well as govern the distribution of routing information between nodes of transport environment 105. It is noted that OSPF and IS-IS utilize various attributes characterizing the links, such as available bandwidth, administration cost, etc. These attributes (or characteristics) may be referred to as traffic engineering parameters and may also be utilized to provision traffic to determined routes.

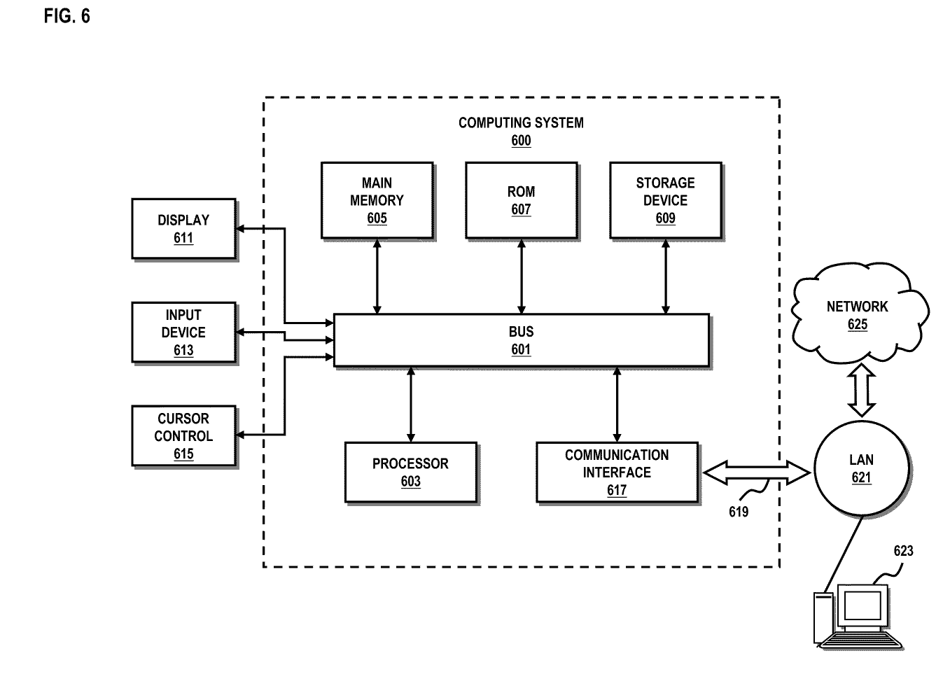

FIG. 2 is a diagram of an aggregation node configured to assign addressing information to encrypted network traffic, according to an exemplary embodiment. For descriptive purposes, aggregation node (or node) 200 is described with respect to packet switching; however, node 200 may include functionality for burst switching, time division multiplexing, wavelength division multiplexing, or any other suitable signal transfer scheme. As shown, node 200 includes input line cards 201a-201n, output line cards 203a-203n, control module 205, and switch section 207; however, it is contemplated that node 200 may embody many forms. For example, node 200 may comprise computing hardware (such as described with respect to FIG. 6), as well as include one or more components configured to execute one or more of the processes described herein. It is also contemplated that the components of node 200 may be combined, located in separate structures, or separate physical locations.

According to one embodiment, input line cards 201a-201n act as “n” input interfaces (e.g., ingress ports) to node 200 from “n” transmitting sources (e.g., services 117a-117n), while output line cards 203a-203n act as “n” output interfaces (e.g., egress ports) from node 200 to “n” destination nodes, such as edge node 109. It is also contemplated that output line cards 203a-203n may relate to “n” output interfaces associated with “n” physical and/or logical links (or pathways) bundled (or otherwise aggregated) to comprise a link, such as link 113. As such, when units of transmission (e.g., packets) arrive at node 200, input line cards 201a-201n port packets to receiving interface 209 of switch section 207. Receiving interface 209 separates headers and payloads from individual packets. Header information is provided to control module 205 for routing purposes, whereas the payloads are encrypted via encryption module 211 and switched to destination output line cards 203a-203b via switch fabric 213 and sending interface 215. That is, control interface 205 is configured to provision one or more channels through switch fabric 213 based on the header information and system 100 topological information. Accordingly, switch fabric 213 routes encrypted payloads to appropriate pathways on sending interface 215, whereby updated headers are combined with encrypted, switched payloads via sending interface 215.

In exemplary embodiments, sending interface 215 includes addressing module 217 configured to determine and assign addressing information to encrypted, switched payloads. It is noted that the addressing information may include dynamically generated addresses and/or addresses retrieved from, for instance, one or more memories (e.g., memory 219) of or associated with node 200. According to one embodiment, addressing module 217 is configured to dynamically generate pseudo-addresses for received units of transmission based on source and/or destination addressing information corresponding to CPEs associated with the received units of transmission. This source and destination addressing information may be extracted (or otherwise parsed) from one or more header fields and/or field segments of units of transmission received at node 200, such as the header information provided to control module 205 by receiving interface 209. It is noted that, in certain embodiments, those units of transmission associated with a particular flow or sub-flow of network traffic may be assigned a same pseudo-address. In such instances, determining the pseudo-address may include querying memory 219 for a previously generated pseudo-address associated with a particular flow or sub-flow of network traffic that may be uniquely identified based on the source and destination addressing information utilized to originally generate the pseudo-address. It is further noted that pseudo-addresses may be temporary and, thereby, periodically generated and associated with flows or sub-flows of network traffic. At any rate, a pseudo-address may be assigned to one or more header fields and, thereby, combined with encrypted, switched payloads for output to destination nodes (e.g., edge router 109) via output line cards 203a-203n.

Additionally, addressing module 127 may also be configured to assign encrypted, switched payloads with source and destination addressing information related to a source aggregation node that, in this example relates to addressing information of node 200, and a destination aggregation node, which may be an intended aggregation node servicing one or more CPEs associated with the received unit of transmission, such as aggregation node 103. As with the pseudo-addressing information, the source and destination addressing information related to the source and destination aggregation nodes may be assigned to one or more other header fields and combined with the encrypted, switched payload for output to destination nodes (e.g., edge router 109) via output line cards 203a-203n.

FIG. 3 is a flowchart of a process for assigning addressing information to encrypted network traffic, according to an exemplary embodiment. For illustrative purposes, the process is described with reference to FIGS. 1 and 2. It is noted that the steps of the process may be performed in any suitable order or combined in any suitable manner. At step 301, node 200 receives a unit of transmission associated with a flow of network traffic, such as a flow of network traffic corresponding to a particular one of services 117a-117n. For purposes of illustration, it is assumed that the flow of network traffic is between a source (e.g., CPE 119a) and a destination (e.g., CPE 121a) in association with a data service 117a, such as an electronic mail service. For example, the unit of transmission may relate to a message exchanged between CPE 119a and CPE 121a. As such, the received unit of transmission may include a header portion specifying source and destination addressing information for CPEs 119a and 121a, as well as include a payload portion including the message to be exchanged. In this manner, node 200, in step 303, may encrypt the payload portion and/or obfuscate the addressing information associated with CPEs 119a and 121a via, for example, encryption module 211. Obfuscating the source and destination addresses associated with CPEs 119a and 121a would conventionally thwart subsequent traffic hashing techniques based on source/destination addressing information and employed by, for instance, edge router 109. As such, node 200 is configured to dynamically determine and/or assign a pseudo-address to encrypted units of transmission.

In step 305, node 200 via, for example, addressing module 217 may be configured to determine a pseudo-address to assign to the encrypted unit of transmission. According to one embodiment, addressing module 217 is configured to dynamically generate the pseudo-address based on the addressing information (e.g., source and destination addressing information corresponding to CPEs 119a and 121a) specified by the header of the received unit of transmission. Since corresponding units of transmission associated with a particular flow or sub-flow of network traffic may be assigned a same pseudo-address, in other embodiments, addressing module 217 may be configured to retrieve a pseudo-address from, for example, memory 219 based on the addressing information (e.g., source and destination addressing information corresponding to CPEs 119a and 121a) specified by the header of the received unit of transmission. In either case, however, the determined pseudo-address may be assigned to one or more header fields and, thereby, combined with an encrypted, switched payload corresponding to the received unit of transmission via addressing module 217, per step 307. Further, addressing module 217 may assign other addressing information to one or more header fields to be combined with the encrypted, switched payload. For example, in step 309, addressing module may assign source and destination address of source and destination aggregation nodes to the one or more header fields. In this example, the source aggregation node relates to node 200 (or, with reference to FIG. 1, aggregation node 101) and the destination aggregation node corresponds to aggregation node 103. Accordingly, per step 311, transmission of the encrypted unit of transmission having the pseudo-address and the source and destination addresses associated with aggregation nodes 101 and 103 assigned to header portions of the encrypted unit of transmission is initiated. That is, the encrypted unit of transmission is forwarded to edge router 109 for transport over transport environment 105 via one or more of links (or paths) 107, which may be selected from based on traffic hashing and/or other traffic engineering techniques.

FIG. 4 is a diagram of an edge node configured to hash encrypted network traffic, according to an exemplary embodiment. For descriptive purposes, edge node (or node) 400 is described with respect to packet switching; however, node 400 may include functionality for burst switching, time division multiplexing, wavelength division multiplexing, or any other suitable signal transfer scheme. As shown, node 400 includes controller 401, hashing module 403, input ports 405a-405n, memory 407, multiplexor 409, output ports 411a-411n, and switch fabric 413; however, it is contemplated that node 400 may embody many forms. For example, node 400 may comprise computing hardware (such as described with respect to FIG. 6), as well as include one or more components configured to execute one or more of the processes described herein. Further, it is contemplated that the components of node 400 may be combined, located in separate structures, or separate physical locations.

According to exemplary embodiments, a plurality of incoming links are respectively and communicatively coupled to input ports 405a-405n and a plurality of outgoing links are respectively and communicatively coupled to outgoing ports 411a-411n. The incoming links may relate to one or more links (or channels) received from a source aggregation router, such as aggregation router 101, whereas the outgoing links may relate to one or more pathways 107 of transport environment 105, such as one or more label switched paths. As such, incoming links may be handled separately with respect to where units of transmission that arrive on the incoming links are routed, or the units of transmission of the incoming links can be effectively multiplexed and, thereby, handled as a single stream (or flow of network traffic) that is routed to one or more outgoing links via outgoing ports 411a-411n. In certain instances, a multiplexed stream of network traffic may correspond to a flow of network traffic associated with a particular application or service, such as a particular one of services 117a-117n. Therefore, and for the sake of simplicity, input units of transmission to node 400 are described as being handled as a single stream and, thus, incoming links may be applied to multiplexor 409 in order to yield a single stream of incoming units of transmission on line 415. It is noted that line 415 is communicatively coupled to controller 401, hashing module 403, and switch fabric 413.

In exemplary embodiments, controller 401 is configured to be responsive to control information 417 received via line 419, as well as responsive to destination information contained within respective headers of incoming units of transmission. Additionally (or alternatively), control information 417 may be retrieved (or received) from memory 407. In this manner, switch fabric 413 may be configured to route received units of transmission to appropriate output ports of output ports 411a-411n based on control information received from controller 401 via, for instance, line 421. The control information provided to switch fabric via line 421 may, according to exemplary embodiments, be derived based on the destination information contained within respective headers of incoming units of transmission, control information 417, and at least one hash value received from, for example, hashing module 403.

Hashing module 403, in exemplary embodiments, is configured to obtain one or more hash values based on information specified in the headers of incoming units of transmission. It is noted that this information may relate to an entire field, a segment of a field, a number of segments of a field, and/or a number of fields of the headers. According to one particular implementation, the units of transmission received by node 400 are encrypted and, therefore, conventional addressing information relating to an origin of received, encrypted units of transmission and a destination of the received, encrypted units of transmission may be obfuscated, e.g., source and destination addressing information associated with CPEs 119a-119n and/or 121a-121n. Nevertheless, the information utilized by hashing module 403 may relate to pseudo-addressing information assigned to encrypted units of transmission by a “source” aggregation node, such as aggregation node 101 via, for example, addressing module 129. The information may further include addressing information corresponding to the source aggregation node, e.g., aggregation node 101, and addressing information associated with a destination aggregation node, e.g., aggregation node 103. It is generally noted that hashing module 403 may employ any variety of hashing function to obtain the one or more hash values.

According to exemplary embodiments, hashing module 403 is configured to hash the information of an incoming, encrypted unit of transmission to obtain a hash value and forward the hash value to controller 401 for routing purposes. Controller 401 may be further configured to utilize destination addressing information (e.g., addressing information corresponding to a destination aggregation router, such as aggregation router 103) to determine which output port of output ports 411a-411n may be employed for transporting the encrypted unit of transmission over transport environment 105 to the intended destination aggregation router, e.g., aggregation router 103. In certain instances, the determination of which output port to employ may be accomplished based on the hash value and a routing table stored to, for example, memory 407. It is noted that the routing table may be populated based on control information received by, for instance, controller 401 via line 419. Consequently, controller 401 may output the encrypted unit of transmission on any of output ports 411a-411n associated with permissible pathways (e.g., pathways 107) over transport environment 105 capable of forwarding the encrypted unit of transmission to the intended destination aggregation node, e.g., destination aggregation node 103. In this manner, the hash value and/or routing table may be utilized to identify permissible pathways. Selection of one or more particular pathways may be based on algorithmic selection utilizing control information 417, which may relate to one or more characteristics (or traffic engineering parameters) associated with the pathways, such as administrative cost, available bandwidth, connection holding priorities, connection over-subscription factors, connection placement priorities, latency, loading conditions, and like.

FIG. 5 is a flowchart of a process for hashing encrypted network traffic, according to an exemplary embodiment. For illustrative purposes, the process is described with reference to FIGS. 1 and 4. It is noted that the process assumes the existence of one or more previously established (or constructed) pathways (e.g., pathways 113 and 115) between aggregation router 101 and 103 and edge nodes 109 and 111, as well as one or more physical and/or logical pathways 107 between edge nodes 109 and 111 that are configured to transport network traffic over transport environment 105. It is also noted that the steps of the process may be performed in any suitable order or combined in any suitable manner.

At step 501, edge node 400 receives from, for instance, aggregation node 101 an encrypted unit of transmission associated with a flow of network traffic. The encrypted unit of transmission includes header information at least specifying a pseudo-address assigned to the unit of transmission by, for example, aggregation router 101 after encryption of the unit of transmission by, for instance, aggregation node 101. The header information may also specify an address associated with a source aggregation node, e.g., aggregation node 101, and an address associated with a destination aggregation node, such as aggregation node 103. These additional addresses may also have been assigned to the unit of transmission after encryption of the unit of transmission. Accordingly, the pseudo-address, the address associated with the source aggregation node, and the address of the destination aggregation node may not be encrypted and, therefore, may be utilized for the purpose of facilitating traffic hashing by node 400.

Accordingly, the pseudo-address, the address associated with aggregation node 101, and/or the address associated with aggregation node 103 may be hashed to obtain a hash value via, for instance, hashing module 403, per step 503. As previously mentioned, hashing module 403 may employ any variety of hashing function to obtain the hash value. In this manner, the hash value may be provided to, for instance, controller 401 to determine, based on the hash value, one or more output ports and, thereby, outgoing links (or pathways) capable of facilitating transport of the encrypted unit of transmission to aggregation node 103, at step 505. This determination may be based on routing information, e.g., one or more routing tables, stored to, for example, memory 407. For instance, the hash value may be utilized to “look up” output ports corresponding to the hash value. As such, controller 401 may select, in step 507, one or more of these output ports based on one or more traffic engineering parameters corresponding to those pathways associated with the output ports and, thereby, the obtained hash value. In exemplary embodiments, the traffic engineering parameters may correspond to pathway characteristics, such as administrative cost, available bandwidth, connection holding priorities, connection over-subscription factors, connection placement priorities, latency, loading conditions, and like. It is noted that any variety of traffic engineering algorithm may be utilized to select from those output ports identified based on the obtained hash value and/or routing information. Accordingly, edge node 400 may initiate transmission of the encrypted unit of transmission based on the selected particular output port(s), per step 509. That is, node 400 may forward the encrypted unit of transmission to edge router 111 via the selected particular output ports. In turn, edge router 111 may forward the encrypted unit of transmission to aggregation router 103 for decrypting and forwarding to an appropriate CPE based on decrypted addressing information parsed from the decrypted unit of transmission.

The processes described herein for providing both traffic hashing and network level security functions may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

FIG. 6 illustrates computing hardware (e.g., computer system) 600 upon which exemplary embodiments can be implemented. The computer system 600 includes a bus 601 or other communication mechanism for communicating information and a processor 603 coupled to the bus 601 for processing information. The computer system 600 also includes main memory 605, such as a random access memory (RAM) or other dynamic storage device, coupled to the bus 601 for storing information and instructions to be executed by the processor 603. Main memory 605 can also be used for storing temporary variables or other intermediate information during execution of instructions by the processor 603. The computer system 600 may further include a read only memory (ROM) 607 or other static storage device coupled to the bus 601 for storing static information and instructions for the processor 603. A storage device 609, such as a magnetic disk or optical disk, is coupled to the bus 601 for persistently storing information and instructions.

The computer system 600 may be coupled via the bus 601 to a display 611, such as a cathode ray tube (CRT), liquid crystal display, active matrix display, or plasma display, for displaying information to a computer user. An input device 613, such as a keyboard including alphanumeric and other keys, is coupled to the bus 601 for communicating information and command selections to the processor 603. Another type of user input device is a cursor control 615, such as a mouse, a trackball, or cursor direction keys, for communicating direction information and command selections to the processor 603 and for controlling cursor movement on the display 611.

According to an exemplary embodiment, the processes described herein are performed by the computer system 600, in response to the processor 603 executing an arrangement of instructions contained in main memory 605. Such instructions can be read into main memory 605 from another computer-readable medium, such as the storage device 609. Execution of the arrangement of instructions contained in main memory 605 causes the processor 603 to perform the process steps described herein. One or more processors in a multi-processing arrangement may also be employed to execute the instructions contained in main memory 605. In alternative embodiments, hard-wired circuitry may be used in place of or in combination with software instructions to implement exemplary embodiments. Thus, exemplary embodiments are not limited to any specific combination of hardware circuitry and software.

The computer system 600 also includes a communication interface 617 coupled to bus 601. The communication interface 617 provides a two-way data communication coupling to a network link 619 connected to a local network 621. For example, the communication interface 617 may be a digital subscriber line (DSL) card or modem, an integrated services digital network (ISDN) card, a cable modem, a telephone modem, or any other communication interface to provide a data communication connection to a corresponding type of communication line. As another example, communication interface 617 may be a local area network (LAN) card (e.g. for Ethernet™ or an Asynchronous Transfer Model (ATM) network) to provide a data communication connection to a compatible LAN. Wireless links can also be implemented. In any such implementation, communication interface 617 sends and receives electrical, electromagnetic, or optical signals that carry digital data streams representing various types of information. Further, the communication interface 617 can include peripheral interface devices, such as a Universal Serial Bus (USB) interface, a PCMCIA (Personal Computer Memory Card International Association) interface, etc. Although a single communication interface 617 is depicted in FIG. 6, multiple communication interfaces can also be employed.

The network link 619 typically provides data communication through one or more networks to other data devices. For example, the network link 619 may provide a connection through local network 621 to a host computer 623, which has connectivity to a network 625 (e.g. a wide area network (WAN) or the global packet data communication network now commonly referred to as the “Internet”) or to data equipment operated by a service provider. The local network 621 and the network 625 both use electrical, electromagnetic, or optical signals to convey information and instructions. The signals through the various networks and the signals on the network link 619 and through the communication interface 617, which communicate digital data with the computer system 600, are exemplary forms of carrier waves bearing the information and instructions.

The computer system 600 can send messages and receive data, including program code, through the network(s), the network link 619, and the communication interface 617. In the Internet example, a server (not shown) might transmit requested code belonging to an application program for implementing an exemplary embodiment through the network 625, the local network 621 and the communication interface 617. The processor 603 may execute the transmitted code while being received and/or store the code in the storage device 609, or other non-volatile storage for later execution. In this manner, the computer system 600 may obtain application code in the form of a carrier wave.

The term “computer-readable medium” as used herein refers to any medium that participates in providing instructions to the processor 603 for execution. Such a medium may take many forms, including but not limited to computer-readable storage medium ((or non-transitory)—i.e., non-volatile media and volatile media), and transmission media. Non-volatile media include, for example, optical or magnetic disks, such as the storage device 609. Volatile media include dynamic memory, such as main memory 605. Transmission media include coaxial cables, copper wire and fiber optics, including the wires that comprise the bus 601. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the exemplary embodiments may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
receiving, at a routing node, a unit of transmission associated with a flow of network traffic;
encrypting the unit of transmission;
determining a pseudo-address to assign to the encrypted unit of transmission; and
assigning the pseudo-address to the encrypted unit of transmission.

2. A method according to claim 1, further comprising:
generating a random address; and
associating the random address with the flow of network traffic to uniquely identify the flow of network traffic,
wherein the random address is utilized as the pseudo-address, and each unit of transmission, including the unit of transmission, corresponding to the flow of network traffic is assigned the pseudo-address.

3. A method according to claim 2, wherein the random address is generated periodically.

4. A method according to claim 2, wherein the random address is generated based on a source address and a destination address corresponding to endpoints of the flow of network traffic.

5. A method according to claim 1, further comprising:
assigning an address associated with the routing node to the encrypted unit of transmission; and
initiating transmission of the encrypted unit of transmission having the pseudo-address and the address assigned thereto.

6. An apparatus comprising:
at least one processor; and
at least one memory including computer program code, the at least one memory and computer program code being configured, with the at least one processor, to cause the apparatus at least to:
receive a unit of transmission associated with a flow of network traffic,
encrypt the unit of transmission,
determine a pseudo-address to assign to the encrypted unit of transmission, and
assign the pseudo-address to the encrypted unit of transmission.

7. An apparatus according to claim 6, wherein the apparatus is at least further caused to:
generate a random address; and
associate the random address with the flow of network traffic to uniquely identify the flow of network traffic,
wherein the random address is utilized as the pseudo-address, and each unit of transmission, including the unit of transmission, corresponding to the flow of network traffic is assigned the pseudo-address.

8. An apparatus according to claim 7, wherein the random address is generated periodically.

9. An apparatus according to claim 7, wherein the random address is generated based on a source address and a destination address corresponding to endpoints of the flow of network traffic.

10. An apparatus according to claim 6, wherein the apparatus is at least further caused to:
assign an address associated with the routing node to the encrypted unit of transmission; and
initiate transmission of the encrypted unit of transmission having the pseudo-address and the address assigned thereto.

11. A method comprising:
receiving, from a routing node, an encrypted unit of transmission at least specifying a pseudo-address and an address associated with the routing node;
hashing the pseudo-address and the address associated with the routing node to obtain a hash value; and
initiating transmission of the encrypted unit of transmission based on the hash value.

12. A method according to claim 11, wherein the encrypted unit of transmission at least also specifies an address associated with a destination routing node and the step of hashing also includes hashing the address associated with the destination routing node.

13. A method according to claim 12, wherein initiating transmission includes initiating transmission to the destination routing node.

14. A method according to claim 11, wherein the flow of network traffic corresponds to one of a plurality of services including data, voice, and video services.

15. A method according to claim 14, wherein transmission is initiated over at least one optical network including a multiprotocol label switching domain.

16. An apparatus comprising:
at least one processor; and
at least one memory including computer program code, the at least one memory and computer program code being configured, with the at least one processor, to cause the apparatus at least to:
receive, from a routing node, an encrypted unit of transmission at least specifying a pseudo-address and an address associated with the routing node,
hash the pseudo-address and the address associated with the routing node to obtain a hash value, and
initiate transmission of the encrypted unit of transmission based on the hash value.

17. An apparatus according to claim 16, wherein the encrypted unit of transmission at least also specifies an address associated with a destination routing node, the apparatus being further caused at least to additionally hash the address associated with the destination routing node to obtain the hash value.

18. An apparatus according to claim 17, wherein initiating transmission includes initiating transmission to the destination routing node.

19. An apparatus according to claim 16, wherein the flow of network traffic corresponds to one of a plurality of services including data, voice, and video services.

20. An apparatus according to claim 19, wherein transmission is initiated over at least one optical network including a multiprotocol label switching domain.
